(19) United States
(12) Patent Application Publication
(10) Pub. No.: US 2005/0161978 A1
(43) Pub. Date: Jul. 28, 2005

(54) SPLIT TILTING TRAILER FOR OFF-ROAD VEHICLES

(76) Inventor: Leavitt John Barton, Campton, NH (US)

Correspondence Address: DECKER LAW OFFICE, 1 NEW HAMPSHIRE AVE., SUITE 125, PORTSMOUTH, NH, 03801, US

(21) Appl. No.: 10/905,778

(22) Filed: Jan. 20, 2005

Related U.S. Application Data
(60) Provisional application No. 60/481,936, filed on Jan. 22, 2004.

(51) Int. Cl. B62D 33/00

(52) U.S. Cl. 296/186.2

(57) ABSTRACT

A trailer for off-road vehicles that can be loaded and unloaded easily by one person without the need for ramps having side-by-side beds that independently tilt while the trailer is hitched to the tow vehicle, and locked in the horizontal position for transportation. The beds are balanced so that they gently tilt back when they are not locked. A coverall can be provided to protect the vehicles during transportation.

### BACKGROUND

1. Field of the Invention

The invention relates to trailers for transporting off-road vehicles behind a tow vehicle.

2. Description of the Related Art

General duty cars and trucks are easily capable of pulling trailers on which two off-road vehicles are parked side-by-side. Examples of off-road vehicles include, without limitation, snowmobiles, ATVs, ATCs, and motorcycles. Some trailers presently in existence require the user to use a separate ramp to drive the vehicle onto the trailer. Such ramps are hazardous to use because the ramps are flimsy, do not store well on the trailer or the tow vehicle, and the vehicle can tip easily while traveling up the ramp.

The other method to load the trailer is to unhitch the trailer from the tow vehicle and tilt the trailer backward for loading. This is a difficult maneuver that cannot be done by one person.

As they are typically used, two or more people will take off-road vehicles out for trail riding. However, they may not arrive back at the tow vehicle at the same time at the end of the day. Sometimes, one of the riders makes a wrong turn and must be picked up elsewhere. Often, one vehicle will break down, or run out of gas, and need to be picked up by the tow vehicle. Loading and unloading a vehicle with one person can be difficult or even impossible. What is needed, therefore, is a trailer for off-road vehicles that can be loaded and unloaded easily, by one person, that does not require separate ramps.

### SUMMARY

A trailer for off-road vehicles that can be loaded and unloaded easily by one person without the need for ramps is a trailer having side-by-side beds mounted on a frame that independently tilt while the trailer is hitched to the tow vehicle, and locked in the horizontal position for transportation. The vehicles can be covered for transportation by a coverall. These and other features and embodiments of the invention will be made clear in the following drawings, description, and claims

### DRAWINGS

FIG. 1 is a side elevation of a split tilting trailer and coverall according to the present invention.

FIG. 2 is a plan view of the frame assembly.

FIG. 3 is a plan view of the bed assembly.

FIG. 4 is a plan view of the bed assembled to the frame.

FIG. 5 is a plan view of the bed assembly with decking and non-skid surface applied.

FIG. 6 is a cutaway section of axle and hinge assembly.

### DESCRIPTION

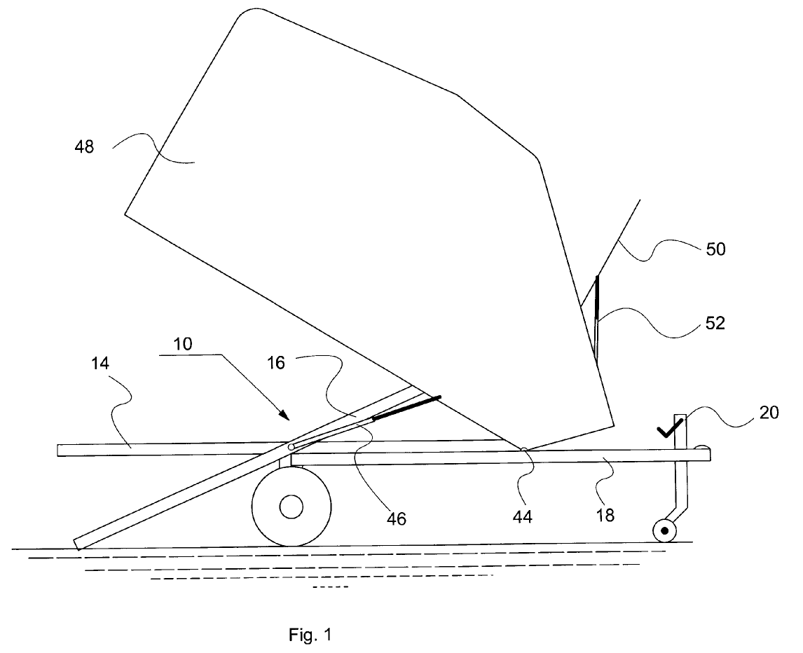

A trailer for off-road vehicles that can be operated by one person has a tongue and wheel frame hingedly connected to two side-by-side beds and latch mechanisms. FIG. 1 is a side view of the trailer 10 with the right side bed 16 tilted for loading and unloading. The left side bed 14 remains horizontal. Both beds are secured with a hinge, not shown in this view, to a tongue and wheel frame 18. Standard trailer landing gear 20 is shown at the tongue of the frame 18.

An optional coverall 48 can be provided hingledly attached to the frame 18 by a hinge means 44. The coverall 48 is preferably a rigid, unitary cover, but it can be split in a way corresponding to the beds 14, 16. The coverall 48 is shown tilted upward and supported in that position by a coverall support means 46. The coverall support means 46 can be a gas strut assembly, or a rigid member. Note that the right side bed 16 can be tilted toward the unloading position and not interfere with the coverall 48. The coverall 48 is preferably provided with a coverall hatch 50 that provides access to the vehicles when the hatch 50 is opened. The hatch 50 can be supported in an open position by a hatch support means 52. The hatch support means 52 can be a gas strut assembly, or a rigid member.

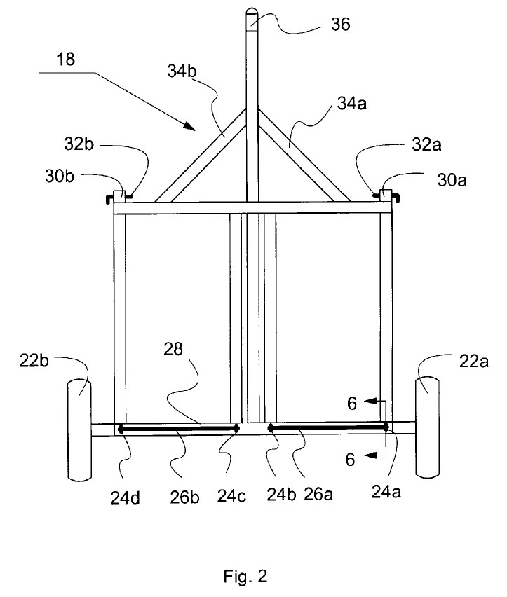

FIG. 2 is an overhead view of the tongue and wheel frame assembly 18. A standard ball receiver assembly 36 is mounted on the tongue, to which the other frame hardware is attached. Opposite the tongue is an axle assembly 28, to which the right and left tires 22a and 22b are attached. Axle assemblies can be purchased as a complete unit. The preferred embodiment uses a DURA-FLEX rubber torsion axle from QDS/Henschen, Inc. The axle assembly 28 is bolted or welded onto the frame. Braces 34a, 34b may be provided to stabilize the frame and add strength.

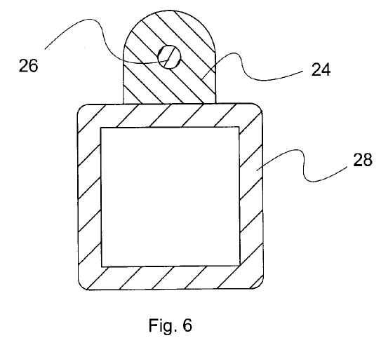

The right and left sides of the frame 18 each have two hinge supports 24a, 24b, 24c, and 24d (together referred to as 24) attached to the axle assembly 28. Through the hinge supports 24 are secured independent hinge rods 26a, 26b on the right and left sides axially aligned with the axle assembly 28. Details of this arrangement are shown in Section 6-6 and FIG. 6.

At the forward corners of the square portion of the frame assembly 18 is at least one latch mechanism for each side. The latch mechanisms are designed to hold each side of the bed in a horizontal position for transporting the trailer. The latch mechanisms comprise a frame latch block 30a, 30b attached to the frame 18, preferably by welding. A hole is provided in each frame latch block adapted to accept a pin 32a, 32b that will engage a latch mechanism on the beds.

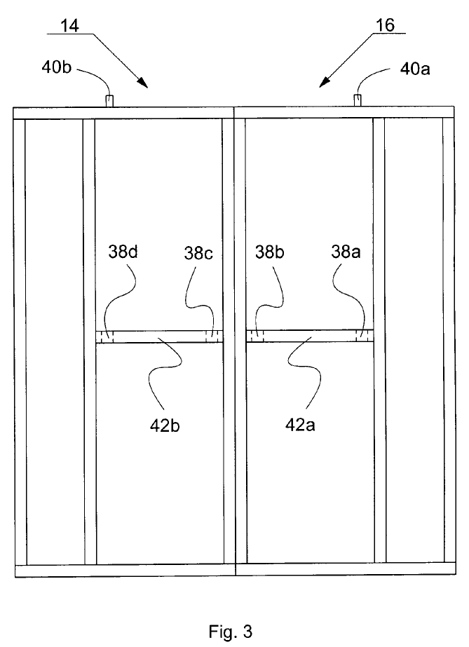

FIG. 3 is an overhead view of the right side bed 16 and left side bed 14. The beds should have some sort of a deck on them to enable them to carry an off-road vehicle. The decks are not shown in this figure to make it easier to view the complete assembly. At least one bed latch block 40a, 40b is attached to the forward edge of the bed, and is provided with a hole adapted to receive the pins 32a, 32b from FIG. 2. The bed latch blocks 40a, 40b have holes inside that are designed to align with the holes in the frame latch blocks to receive the pins.

At least two hinge blocks 38a, 38b, 38c, 38d are provided for each bed 16,14. The hinge blocks each have holes in them adapted to receive the hinge rods 26a, 26b. The hinge blocks are secured to bed support members 42a, 42b, which in turn support the beds and the vehicles that are transported upon them.

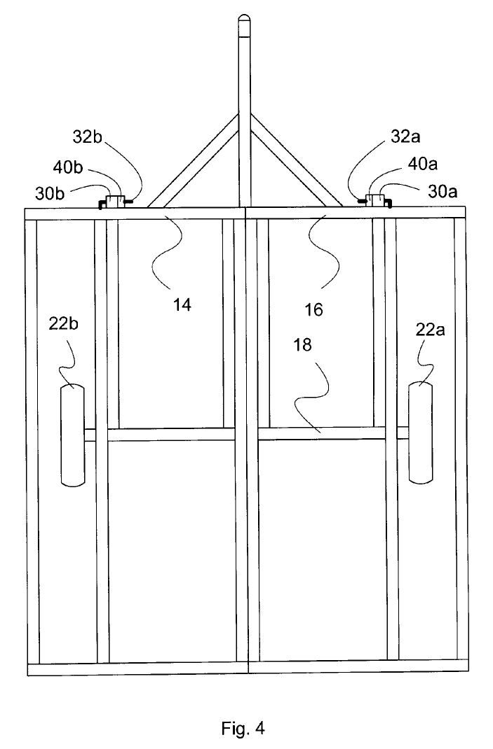

FIG. 4 is an overhead view of the beds 14, 16 assembled on top of the frame 18. In this view, the latch blocks are pinned together to keep the beds in the horizontal position. The right bed 16 and left bed 14 are not secured to each other. Each is free to rotate on its hinge on the frame 18. A helpful design consideration is to mount the beds 14, 16 so that their balance points are slightly behind the hinge point. This way, when the pins 32a, 32b are released when the beds are not supporting a vehicle, the back end of the bed will gently tip so that the back end of the bed is touching the ground. A snowmobile or ATV can simply climb the back end of the bed without assistance. When the balance point of the bed plus vehicle passes over the hinge, the bed will tip back to horizontal.

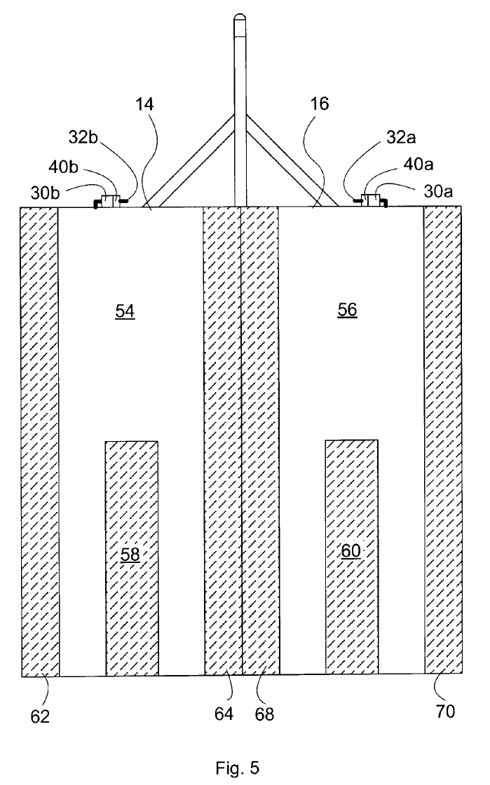

FIG. 5 is a plan view of the beds with decking disposed on top. The decking on each side 54, 56 is preferably plywood, but other materials like sheet metal, expanded metal, and fiberglass can be used. Optionally disposed on top of the decking 54, 56 is a non-skid layer on the left side 58 and the right side 60 extending from the rear end of the trailer to approximately the middle, and about the width of a typical snowmobile track. The purpose of this layer is to provide a snowmobile with traction for loading and unloading under its own power. A non-skid layer is also disposed along substantially the entire length of the left side 62 of the left bed 14 and of the right side 64 of the left bed 14. Likewise, a non-skid layer is also disposed along substantially the entire length of the left side 68 of the right bed 16 and of the right side 70 of the right bed 16. The purpose of these layers is to provide traction to a user during loading and unloading, and while mounting and dismounting a vehicle. Another benefit of this arrangement is that snowmobile skis will slide along the decking surface without contacting a non-skid surface. The non-skid surface in the middle of the beds only needs to extend as far as a snowmobile's track. Only a user's feet and snowmobile tracks need to contact a non-skid surface, which is what this invention provides.

FIG. 6 is a cross section of the frame hinge assembly mounted on the axle assembly 28. The preferred embodiment of the axle members, as well as the other parts of the trailer, is that they are constructed of square structural tubing as shown. The hinge supports 24 are attached to the axle assembly 28, preferably by welding. A hole is provided in the hinge supports 24 to receive a hinge rod 26. The hinge rods 26 and hinge supports 24 must be designed to support the weight of the beds and the vehicles they carry during transportation, plus an adequate safety margin.

To load the trailer with an off-road vehicle with the trailer hitched, the single operator would first raise the coverall 48 and release the pin 32 for a bed 14, 16 of the selected side of the trailer. Because the beds are weighted heavier at the back end, or else the pivot point is forward of the center of mass, the back end would then gently pivot on the hinge rod 26 until the back end of the bed rests on the ground. The operator can then drive the vehicle up the bed from the back. When he reaches the pivot point, the bed and vehicle will automatically tip forward to the horizontal position. The operator would dismount from the vehicle and replace the pin 32 to lock the bed 14, 16 in the horizontal position. The vehicle would be further tied to the trailer to prevent movement during transportation, and the coverall 48 would be lowered. Unloading the vehicle is simply the reverse of loading.

While there have been described what are at present considered to be the preferred embodiments of this invention, it will be obvious to those skilled in the art that various changes and modifications may be made therein without departing from the invention and it is, therefore, aimed to cover all such changes and modifications as fall within the true spirit and scope of the invention.

1. A trailer for off-road vehicles that can be loaded and unloaded by a single user comprising:
a wheel and axle assembly;
a frame assembly having a front edge and a rear edge opposite the front edge, the frame assembly attached to the wheel and axle assembly near the frame assembly rear edge, the frame assembly and wheel and axle assembly being adapted to support the weight of two off-road vehicles; and
two adjacent beds independently hingedly attached at a respective pivot point to the frame assembly over the frame assembly rear edge, whereby the beds can independently rotate so that a bed rear edge can be lowered and a user can drive a vehicle onto a bed that counter-rotates after the center of mass of the bed and vehicle passes the over the pivot point, thereby enabling a single user to load and unload the trailer.

2. The trailer of claim 1, further comprising:
a bed latch mechanism attached to each bed; and
two frame latch mechanisms attached to the frame assembly and corresponding to the bed latch mechanisms and adapted to latch the bed and frame together for transporting the trailer.

3. The trailer of claim 2, each bed having at least one hinge block for hingedly attaching the beds to the frame assembly at a point between the balance point of the bed and bed latch mechanism.

4. The trailer of claim 1, said frame assembly comprising:
a trailer hitch receiver;
a tongue having a front end and a rear end, the hitch receiver being secured to the tongue front end;
a frame having a front end and a rear end, the tongue rear end attached to the frame front end;
at least one frame latch mechanism attached to the frame front end;
a plurality of hinge rod supports attached to the frame rear end; and
two hinge rods attached to the frame above the wheel and axle assembly through the hinge rod supports.

5. The trailer of claim 1, further comprising a sheet of decking material disposed on each bed.

6. The trailer of claim 5, wherein the decking material is made of at least one taken from the group consisting of plywood, sheet metal, expanded metal, and fiberglass.

7. The trailer of claim 5, further comprising a non-skid layer disposed upon the decking material.

8. The trailer of claim 7, wherein a strip of non-skid layer is disposed on opposite sides of each bed and is adapted to provide traction to a user during loading, unloading, mounting, and dismounting a vehicle that is on the trailer.

9. The trailer of claim 7, wherein a strip of non-skid layer is disposed along the longitudinal center of each bed, the layer being approximately the width of a snowmobile track, and extending from each bed rear edge approximately half the length of the bed, whereby the location of the non-skid layer enables a user to load a snowmobile without a snowmobile's skis contacting the non-skid surface, but enables a snowmobile track to contact a non-skid surface.

10. The trailer of claim 1 further comprising a coverall hingedly secured to the frame assembly near the frame assembly front edge, the coverall adapted to enclose at least one off-road vehicle.

11. The trailer of claim 10, further comprising a coverall support means having a first end and a second end, the first end being secured to a bed and the second end being secured to the coverall, whereby the coverall can be supported in an upward position by the coverall support means to enable loading and unloading a vehicle.

12. The trailer of claim 11, wherein the coverall support means is a gas strut assembly.

13. The trailer of claim 10, further comprising a coverall hatch adapted to provide access to vehicles on the trailer when the hatch is in an open position.

14. The trailer of claim 13, further comprising a coverall hatch support means having a first end and a second end, the first end being secured to the coverall and the second end being secured to the coverall hatch, whereby the coverall hatch can be supported in an upward position by the coverall support means to enable access to vehicles on the trailer.

15. A trailer for off-road vehicles that can be loaded and unloaded by a single user comprising:
a wheel and axle assembly;
a frame assembly having a front edge and a rear edge opposite the front edge, the frame assembly attached to the wheel and axle assembly near the frame assembly rear edge, the frame assembly and wheel and axle assembly being adapted to support the weight of two off-road vehicles;
a coverall hingedly secured to the frame assembly near the frame assembly front edge, the coverall adapted to enclose at least one off-road vehicle; and
two adjacent beds independently hingedly attached at a respective pivot point to the frame assembly over the frame assembly rear edge, whereby the beds can independently rotate so that a rear edge can be lowered and a user can drive a vehicle onto a bed that counter-rotates after the center of mass of the bed and vehicle passes the over the pivot point, thereby enabling a single user to load and unload the trailer.

16. The trailer of claim 15, further comprising:
a bed latch mechanism attached to each bed; and
two frame latch mechanisms attached to the frame assembly and corresponding to the bed latch mechanisms and adapted to latch the bed and frame together for transporting the trailer.

17. The trailer of claim 15, said frame assembly comprising:
a trailer hitch receiver;
a tongue having a front end and a rear end, the hitch receiver being secured to the tongue front end;
a frame having a front end and a rear end, the tongue rear end attached to the frame front end;
at least one frame latch mechanism attached to the frame front end;
a plurality of hinge rod supports attached to the frame rear end; and
two hinge rods attached to the frame above the wheel and axle assembly through the hinge rod supports.

18. The trailer of claim 15, further comprising a non-skid layer disposed upon the decking material.

19. The trailer of claim 18, wherein a strip of non-skid layer is disposed on opposite sides of each bed and is adapted to provide traction to a user during loading, unloading, mounting, and dismounting a vehicle that is on the trailer.

20. The trailer of claim 18, wherein a strip of non-skid layer is disposed along the longitudinal center of each bed, the layer being approximately the width of a snowmobile track, and extending from each bed rear edge approximately half the length of the bed, whereby the location of the non-skid layer enables a user to load a snowmobile without a snowmobile's skis contacting the non-skid surface, but enables a snowmobile track to contact a non-skid surface.
